(19) United States
(12) Patent Application Publication
(10) Pub. No.: US 2008/0184326 A1
(43) Pub. Date: Jul. 31, 2008

(54) COMMUNITY AND/OR CHAT-BASED CONTENT RECORDING AND CONSUMPTION

(76) Inventor: Satoshi Nakajima, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/875,479

(22) Filed: Oct. 19, 2007

Related U.S. Application Data
(60) Provisional application No. 60/862,188, filed on Oct. 19, 2006.
(60) Provisional application No. 60/862,189, filed on Oct. 19, 2006.
(60) Provisional application No. 60/862,191, filed on Oct. 19, 2006.

(51) Int. Cl. H04N 7/173; H04N 5/445

(52) U.S. Cl. 725/133; 725/131; 725/114; 725/38

(57) ABSTRACT

Methods and an apparatus for providing recording and rendering devices with customized content and/or content information based on one or more communities that users of the devices are members of, are described herein. The communities may be collections of device users located in a given geographic area, having a certain interest, or sharing a demographic trait. The customized content and/or content info include one or more of broadcast or multicast contents, a programming guide, a bundle of a plurality of broadcast or multicast contents, a directive to record broadcast or multicast content, or other contents that members of the community are currently watching or watch most frequently. In one embodiment, the content may also include chat data associated with community members.

### RELATED APPLICATIONS

The present application claims priority to U.S. Provisional Application 60/862,188, entitled “Community-informed Customized Content Services”, filed on Oct. 19, 2006; to U.S. Provisional Application 60/862,189, entitled “Chat-Based Customized Content Services”, filed on Oct. 19, 2006; and to U.S. Provisional Application 60/862,191, entitled “Community and/or Chat-Based Content Recording and Consumption”, filed on Oct. 19, 2006. The specifications of the 60/862,188, 60/862,189, and 60/862,191 provisional applications are hereby fully incorporated by reference.

### FIELD OF THE INVENTION

The present invention relates to the fields of media and entertainment; in particular, to recording and rendering devices, methods practiced thereon, and apparatuses for community and/or chat based content recording and consumption.

### BACKGROUND OF THE INVENTION

Advances in television (TV), multimedia presentation, and digital networking technologies have made possible the provisioning of customized bundles of television contents, such as channels, on a per-subscription basis. Television consumers may subscribe to cable services or to satellite-driven content services to receive packages of channels defined by the service providers, often based on metrics such as market research. Packages may include a certain number of channels, a certain channel content-type, such as high definition channels, and/or a certain theme, such as a sports package.

In a related area of technology, advances in TV and video recording device technologies have given rise to a number of content recording devices, such as video cassette recorders (VCR), and more recently, digital video device (DVD) recorders, and digital video recording devices (DVR), such as TiVo DVRs. Each of these devices requires its users to pick the particular contents that are to be recorded.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of various embodiments of the present invention;

FIG. 2 is a block diagram illustrating an example television set suitable for use to practice the present invention, in accordance with various embodiments;

FIG. 3 is a block diagram illustrating an example computer system suitable for use to practice the present invention, in accordance with various embodiments; and

FIG. 4 illustrates a flowchart view of selected recording device operations, in accordance with various embodiments;

FIG. 5 illustrates a flowchart view of selected television operations, in accordance with various embodiments; and

FIG. 6 illustrates a flowchart view of selected server operations, in accordance with various embodiments.

### DETAILED DESCRIPTION OF EMBODIMENTS OF THE INVENTION

Illustrative embodiments of the present invention include, but are not limited to, methods and an apparatus for providing recording and rendering devices with customized content and/or content information based on one or more communities that users of the devices are members of. The communities may be collections of device users located in a given geographic area, having a certain interest, or sharing a demographic trait. The customized content and/or content info include one or more of broadcast or multicast contents, a programming guide, a bundle of a plurality of broadcast or multicast contents, a directive to record broadcast or multicast content, or other contents that members of the community are currently watching or watch most frequently. In one embodiment, the content may also include chat data associated with community members.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

As used herein, “remotely disposed” means “not in the same premise”, and that the devices which are remotely disposed from each other may be coupled with each other via local and/or wild area network(s), each may be wired or wireless.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

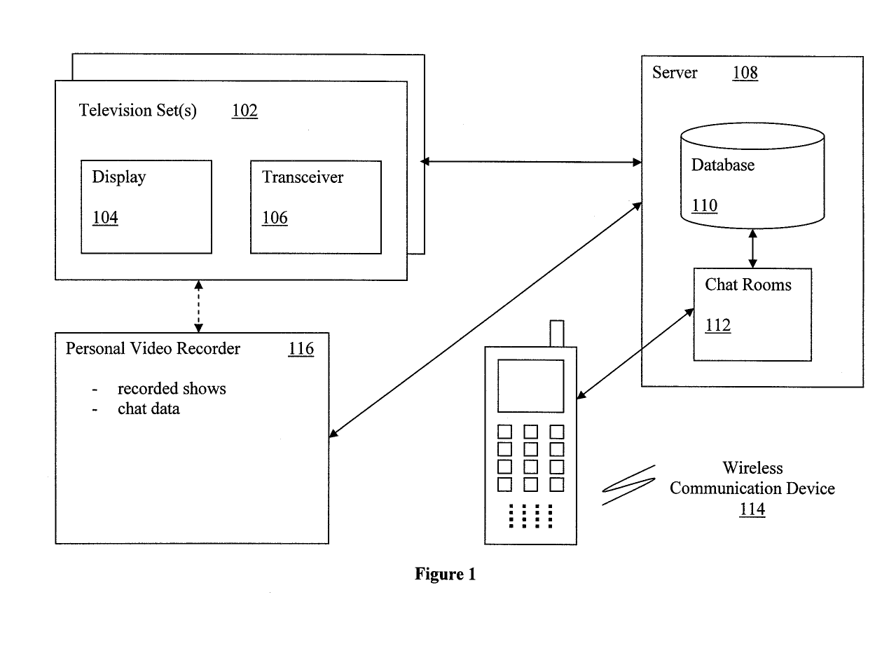

FIG. 1 illustrates an overview of various embodiments of the present invention. As illustrated, a recording device 116, such as a personal video recorder (hereinafter, PVR 116), may be communicatively coupled to a server 108 and receive recording assistance information comprised of customized content and/or content information. Such customized content and/or content information may include a list of programs to record and/or a directive to record certain programs based at least on one or more communities that a user of PVR 116 is a member of. The customized content and/or content information may further comprise a list of a community's current favorite or most frequently watched broadcast or multicast contents, such as television programs, as well as other information describing those programs to enable their recording.

In one embodiment, the customized content and/or content information may further or instead comprise chat information associated with the content, such as periodic indications that chatting (e.g. number of chatters and/or messages) has reached at threshold. In various embodiments, the chat information may be associated with various segments of the recorded/broadcast/multicast content. As a result, content recorded by PVR 116 may be subsequently consumed based on an associated chat, thus allowing PVR 116 users to view only segments with chat activities exceeding certain thresholds. Also as a result, PVR 116 may record only segments with chat activities exceeding certain thresholds.

The chat data may be associated with one or more chat rooms 112 of server 108. Chat rooms 112 users may chat using wireless communication devices 114. Wireless communication device 114 users may also be members of the one or more communities that a PVR 116 user is a member of.

As is further shown, the server 108 may be communicatively coupled to a television set 102 (hereinafter, TV 102) and may provide TV 102 with customized contents and/or content information, including chat data, based at least in part on one or more communities that a user of TV 102 is a member of. In some embodiments, the chat data that is provided to TV 102 may be the same chat data that is provided to PVR 116.

Also, TV 102 may include a display 104 that is adapted to render conventional television/broadcast/multicast content, customized content, and/or content information for a TV 102 viewer, a transceiver 106 adapted to communicate with server 108, and logic adapted to receive and render customized contents and/or content information, such as a chat data associated with chat rooms 112 of server 108. In one embodiment, TV 102 may also allow a user to directly select one or more communities to belong to, and to receive chat data associated with chat rooms 112 participated in by members of those communities, including data related to chatting activity of the TV 102 user.

In various embodiments, server 108 may include logic adapted to create customized contents and/or content information for members of a community and to provide those contents to the members. Server 108 may also include a database 110 configured to store information about communities, their members, and their members' chatting activities. Also, server 108 may include one or more chat rooms 112 that may facilitate users of a plurality of wireless communication devices 114 in engaging in chat activities.

In one embodiment, TV 102 and PVR 116 may be physically coupled and may share a subscription to the services of server 108. In other embodiments, a subscriber to server 108's services may have only one of TV 102, PVR, 116, and wireless communication device 114.

In various embodiments, TV 102, except for the logic adapted perform the operations of embodiments of the present invention, may be any sort of TV known in the art. TV 102 may receive analog or digital audiovisual signals through an attached cable, such as a serial connector, a parallel connector, a USB connector, or an IEEE 1394 high performance serial bus, or through wireless means, either using optical technologies, such as an Infrared Data Association (IrDA) standard based optical connection, or using WiFi technologies, such as Bluetooth or IEEE 802.11 based electro-magnetic wireless connections. Also or instead, TV 102 may receive UHF- or VHF-band transmissions via an antenna. In addition to the audiovisual signals, TV 102 may further receive data transmissions through the same or a different cable/wireless means. For example, audiovisual signals may be received through an analog or digital cable, and data transmissions may be received through an Ethernet connection. TV 102 may then also be equipped to receive one more types of connectors, such as Coaxial connectors, component video connectors, S-Video connectors, and Ethernet connectors, among may others known in the art. In addition to receiving connectors for audiovisual signals and data transmissions, TV 102 may also be adapted to receive connectors from peripheral apparatuses such as DVD players, VCRs, personal video recorders (PRVs), and video game consoles, among many others. In one embodiment, TV 102 may also be adapted to receive a connector from PVR 116.

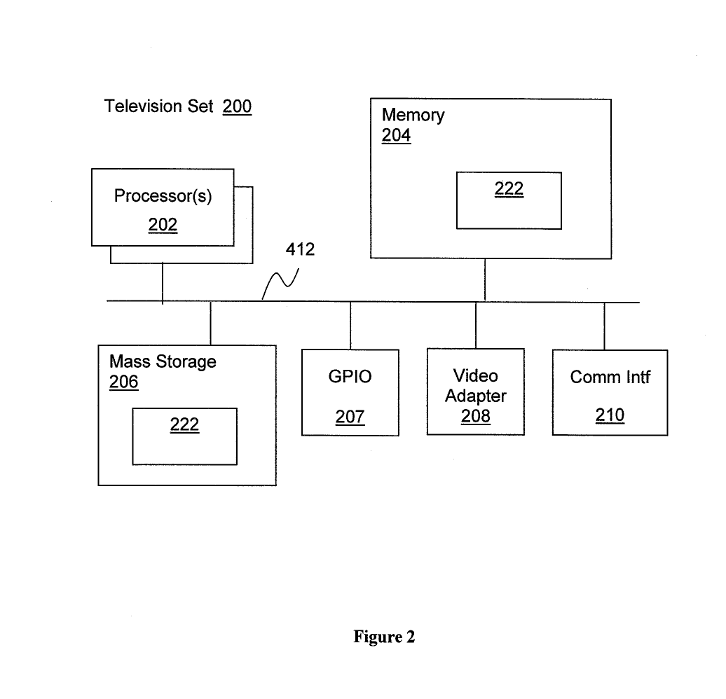

To render images, TV 102 may also make use of any display known in the art for display 104, such as a CRT display, projection display, flat-panel LCD display, or plasma display. For outputting audio signals, TV 102 may include one or more speakers (not shown), which may be stereo speakers or any other sort of speakers known in the art, and may use any format known in the art, such as the NICAM format. In various embodiments, TV 102 may also include a processor, system memory, mass storage, GPIO, and a video adapter, such as those illustrated by FIG. 2 and described in further detail below.

In other embodiments, TV 102 may serve as a controllee apparatus capable of generating interface displays, such as user interfaces enabling channel selection, and may provide such user interface displays to a remote control or similar device. The displays may include associated commands to be transmitted to TV 102 upon interaction with the user interface display through the remote control, whereupon TV 102 may perform operations in accordance with the received commands. Such user interface displays may constitute, for example, graphic numbered buttons to enable channel selection and graphic arrow keys to enable channel browsing. These interfaces may be displayed, for example, on a touch sensitive display of the remote control. Such a controllee apparatus is the subject of recently issued U.S. Pat. No. 7,095,456, entitled “Field Extensible Controllee Sourced Universal Remote Control Method and Apparatus,” and issued Aug. 22, 2006, that patent fully incorporated herein by reference.

In various embodiments, the transceiver 106 of TV 102 may be any of wireless, wired, and/or satellite receiver means to send communications to and receive communications from server 108. In one embodiment, transceiver 106 may comprise wireless means of TV 102 and be adapted to broadcast discovery packets, including a network address of TV 102. Transceiver 106, comprising the wireless means, may also be adapted to receive discovery packets from server 108, and may be adapted to send a response packet, including a network address of TV 102. In yet another embodiment, transceiver 106 may comprise a wired interface of TV 102, such as those described above, and may send discovery/response packets and/or receive discovery packets. As a wired interface, transceiver 106 may, in turn, be locally coupled to another device, such as a router having networking connectivity to a LAN or a WAN, the router having wireless and/or wired means of the sort described above, capable of sending and/or receiving packets. In yet other embodiments, transceiver 106 may comprise a satellite receiver communicatively couple to a satellite dish, capable of sending data to and receiving media, customized contents, and content information from a satellite. The satellite may in turn send data to and receive media, customized contents, and content information from server 108, which may also include a satellite dish and satellite receiver.

In various embodiments, TV 102 may include logic adapted to perform a plurality of operations. The logic may be comprised of one of more processes, or simply of a single module of a process, and may be stored either partially or entirely on TV 102. If stored partially on another device (not shown), the other device may be communicatively coupled to TV 102, and the logic may be executed by processors on either or both of TV 102 and the other device.

In some embodiments, the logic of TV 102 may provide viewers with a log-on mechanism to log-on to a specific user account. Thus, TV 102 may have several user accounts associated with it. In other embodiments, a given TV 102 may have only one user account associated with a television/cable services subscription. In yet other embodiments, the services offered by server 108 to TVs 102 may be the subject of an additional user subscription.

In various embodiments, logic of TV 102 may also provide a TV 102 user with a means to select one or more communities the user wishes to be a member of. Such communities may be, for example, geographic communities, communities organized around a common interest in a particular show or subject matter, communities organized around a demographic trait, such as an age, or communities of related persons, including families. The logic of TV 102 may present a user interface to a user through TV 102, accepting inputs from, for instance, a remote control. If TV 102 is a touch screen, a user may tactually select a graphic component to join a community or to browse among communities to join. In one embodiment, a portion of the logic of TV 102 may be located and executed on another device, such as a personal computer in geographic proximity to TV 102, and the personal computer may provide a user with an interface and means to browse amongst and select communities, and may convey the selection to TV 102. In other embodiments, the logic of TV 102 may allow TV 102 users to define communities, such as a “Peck Family” community, and request other TV 102 users to join the community. Further, a user of TV 102 may receive requests from others to join their communities, and the logic of TV 102 may provide users with facility to accept or reject such requests.

In some embodiments, the logic of TV 102 may further be adapted to receive and render customized contents and/or content information, including chat data associated with one or more chat rooms 112. Chat data may be any associated with of members of communities that the TV 102 user is a member of. For example, a community may be comprised of 4 persons, including the TV 102 user. Two members of that community may be engaged in a chat facilitated by one of the chat rooms 112 of server 108. The members may chat using wireless communication devices 114, the devices 114 engaged in a chat room 112 session. The chat data, in such an example, may include the chatting between the members, as well as the identities of the chatting members, and/or an indication of which member is the most frequent chatter. The logic of TV 102 may then cause the chat-activity data to be rendered, on the display 104 of TV 102. The chat-activity data may be rendered in any fashion known in the art to visually convey information, such as text, graphics, and charts. Continuing with the example, TV 102 may render the names and pictures of the two members engaged in a chat, as well as a session identifier for a chat room 112. The TV 102 user may then make use of a wireless communication device 114 to join the chat, simultaneously chatting and enjoying the contents rendered by TV 102.

In one embodiment, the logic may be further adapted to observe and report viewing data associated with a TV 102 user's viewing of the content information, customized content, and/or other broadcast or multicast content. The data may comprise any number of possible metrics, such as an identifier of a viewed television program or commercial, and/or a duration of viewing the program and/or commercial. The metrics may be stored locally on TV 102, remotely on another device, or may be sent as they are gathered to server 108. The metrics may also be reported in batches at time intervals or in response to some trigger, such as a user changing a channel, powering off TV 102, or accessing a programming guide. In one embodiment, where TV 102 is coupled to PVR 116, TV 102 may observe and report viewing behavior associated with the programs recorded by PVR 116, including which programs were viewed and how much of the programs were viewed.

In various embodiments, the logic of TV 102 may be adapted to receive and render customized content and/or content information received from server 108. The customized content and/or content information may include commercials determined to be relevant to the communities a TV 102 user belongs to, television programs and movies, and a programming guide custom-created for a user based on the communities that the user is a member of, or custom-created for the community. In embodiments, the customized content and/or content information may be updated periodically, such as on a time interval or in response to user/server initiated triggers, the updated additional customized contents reflecting the most recent viewing behavior of the user(s) of TV 102 and of other TVs that have users which are members of the same communities.

In one embodiment, where TV 102 is coupled to PVR 116, the logic of TV 102 may receive and render the contents recorded by PVR 116.

As illustrated, server 108 may be communicatively connected to one or both of TV 102 and PVR 116. In some embodiments, TV 102/PVR 116 and server 108 may be connected by one or more networking fabrics. Such networking fabrics may include one or more of a LAN, a WAN, and the Internet. Communications across the networking fabrics may be facilitated by any communication protocol known in the art, such as the Hypertext Transfer Protocol (HTTP) or the file transfer protocol (FTP), and any transport protocol known in the art, such as the Transmission Control Protocol/Internet Protocol (TCP/IP) suite of protocols. In some embodiments, TV 102/PVR 116 and server 108 may be connected by one or more routers of the networking fabric (not shown). In other embodiments, TV 102/PVR 116 and server 108 may each include a satellite receiver, the receivers coupled to satellite dishes, the dishes adapted to communicate through one or more satellites. The receivers, dishes, and satellites may be any known in the art.

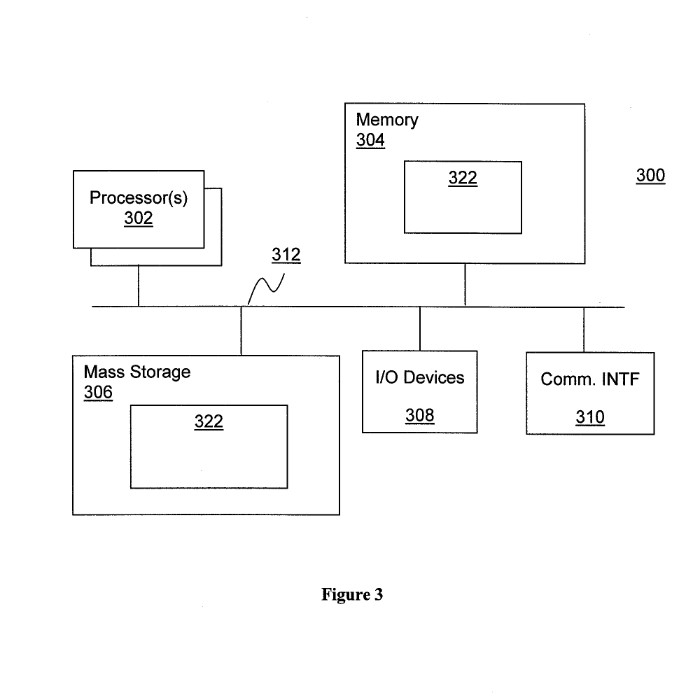

As is shown, server 108 may be any sort of computing device known in the art, except for database 110, chat rooms 112, and the logic adapted to perform the operations described above and below. Server 108 may be a personal computer (PC), a workstation, a server, a router, a mainframe, a modular computer within a blade server or high-density server, a personal digital assistant (PDA), an entertainment center, a set-top box or a mobile device. Further, server 108 may be any single- or multi-processor or processor core central processing unit (CPU) computing system known in the art, except for database 110, chat rooms 112, and the logic adapted to perform the operations described above and below. An exemplary single-/multi-processor or processor core server 108 is illustrated by FIG. 3, and is described in greater detail below.

Also, server 108 may be a server of a service provider providing customized contents, content information, and/or chat facilities to service subscribers. The service may be part of an over-all television/cable services package or may constitute a separate service. In some embodiments, server 108 may include wireless, wired, and/or satellite receiver means, such as those described above in regards to TV 102 and transceiver 106. Such means may be adapted to send customized contents, television content information, and other data, and to receive viewing behavior and other data. Also, server 108 may have telephony/messaging means to facilitate wireless communication device 114 users in engaging in chat activities through a chat room 112 of server 108. Such means may be adapted to send and receive chat data, such as voice and/or text, from wireless communication devices 114.

As illustrated, database 110 may be configured to store data associated with the above described communities, chat rooms 112, viewing data, and/or users, and may be locally disposed on server 108. Database 110 may be any sort of database known in the art, such as a relational database, and may be normalized or de-normalized. Also, database 110 may include any number of tables/records to store data, such as a table for each community listing members of the community and custom contents created to be of interest to those members. Database 110 may also include tables/records for each user, storing for instance, viewing data of the user, customized contents and/or content information for the user, and a list of communities that a given user is a member of. Also, database 110 may include tables/records for each chat room 112, storing for instance, the names of users in a given chat and a number of chat-activity metrics. Further, database 110 may be responsive to queries and create/delete commands received from other processes, such as logic of server 108. In other embodiments, not shown, database 110 may be located on a remote system, also not shown, rather than being locally disposed. In such embodiments, the remote system and server 108 may engage in networked communication. Such a remote system may be a database server.

As is shown, server 108 may include one or more chat rooms 112 to facilitate wireless communication device 114 users in engaging in chat activities. Chat rooms 112 may represent sessions created by logic of server 108. Each chat room 112 session may have a number of participants, and the participants may each be users of the service and members of one or more communities. The chat rooms 112 may provide message routing facilities, sending a message from one wireless communication device 114 user to another, or to all participants in the chat room 112. Also, the chat rooms 112 may provide chat room 112 metadata to wireless communication device 114 users, such as lists of all participants in the chat rooms 112 and statuses of the participants, such as “idle.” Additionally, chat rooms 112 may provide participants with the ability to invite others to participate, such as others that may be members of the same communities as the inviter. Either the chat room 112 session or other logic of server 108 may be configured to create a record for the chat room 112 in database 110 and to write participant names and various metrics to the record. A chat room 112 session may be started by logic of server 108 in response to a user request for a chat session, and may automatically end after each participant has left the chat room 112. In one embodiment, server 108 may maintain a number of persistent chat room 112 sessions, such as a chat room 112 associated with each community. In another embodiment, as soon as a member of a community logs on, logic of the server 108 may create a chat room 112 for that community.

In some embodiments, prior to chatting and/or receiving customized contents and/or content information, a service user must log in first, in any manner known in the art. Upon establishing a service account, logic of server 108 may create a record for each user in database 110 and may store received viewing data from a user in the record associated with the user. The logic may also store security information, such as a password, and may check the password against input received from the user when the user logs in, as a TV 102 user, a PVR 116 user, or a wireless communication device 114 user.

As mentioned, each user may be a member of one or more communities. In some embodiments, the logic of server 108 may create communities by default, such as communities based around television programs, topical areas, and geographic areas, and may automatically assign users to these communities or invite users to join them, providing users with the ultimate authority of whether to accept or reject invitations. In one embodiment, users may themselves create communities on TVs 102, and server 108 may receive the requests for creation of communities. The logic of server 108 may create such communities automatically, or may subject requests to some review, such as by a program that looks for words associated with illegal activities. The received community-creation requests may also include one or more other users to invite, and the logic of server 108 may send invitations to other users to join the new communities. While creating a community, the logic of server 108 may also create a chat room 112, as is described above. Upon creating a community, the logic of server 108 may also create a record for the community in database 110, and may add those who have accepted/been added to the community to the record. Also, logic of server 108 may periodically publish a list of communities to TV 102 users, facilitating the user in browsing among and joining the communities.

As is shown, the logic of server 108 may further provide PVR 116 with recording assistance information, including content information and/or customized content, and may receive viewing data associated with programs recorded by PVR 116 from PVR 116. In other embodiments, as described below, the viewing data associated with programs recorded by PVR 116 may be received from a TV 102 coupled to PVR 116. Upon receiving viewing data associated with programs recorded by PVR 116, the logic of server 108 may store the data in a record of database 110 that is associated with the PVR 116 user. In one embodiment, the logic may also store an additional value with each block of received data to indicate that the viewing data is associated with programs recorded by PVR 116.

In some embodiments, at an interval, such as a time interval or an irregular, trigger-defined interval, the logic of server 108 may generate content information and/or customized content for a PVR 116. The generated content information and/or customized content may include a directive to record broadcast or multicast content, a list of broadcast or multicast contents available for recording and/or purchase, or broadcast or multicast contents. In one embodiment, the content information and/or customized content may further include a list of current favorite programs or most frequently viewed programs for one or more communities that the PVR 116 user is a member of. The logic may create separate lists for each community, or may create a combined list for all of the communities that the PVR 116 user is a member of. To create such content information and/or customized content, the logic of server 108 may determine which communities that a PVR 116 user is a member of by querying database 110. The logic may then retrieve the names of the users that are members of the communities, and may determine from the viewing data of each of the users, for example, a list of current favorites or most frequently viewed programs for each community, or for all the communities as a collective. The logic of server 108 may then cause this content information and/or customized content to be transmitted to the PVR 116 for which it was generated. Also, these operations may be performed periodically, at regular or irregular intervals, thus providing PVRs 116 with updated content information and/or customized content reflecting their recent viewing data.

In one embodiment, the content information and/or customized content generated by the logic of server 108 may further or instead include chat data, such as the chatting between a member of a PVR 116 user's community and another person, the identities of one or more chatters and status information regarding chatters (i.e., such as whether a chatter is idle), and metrics of the frequency of messages in a chat room 112 over a period of time (provided to the PVR 116, for example, as a time plot where message quantity is shown as a function of time). The logic may generate the chat data by querying database 110, and may then provide the chat data to a PVR 116. In various embodiments, the chat data may be associated with different segments of the recorded content.

In some embodiments, logic of server 108 may also create or update chat data. At some interval, such as a time interval or irregular, trigger-defined intervals, the logic may determine the chat rooms associated with the communities that a TV 102/PVR 116 user is a member of, and may determine one or more metrics describing the chat rooms, such as participants in a particular chat, the name of the most frequent chatter in a chat room 112, frequencies of messages sent by member(s) of a community over a time period (e.g., as a time plot, as described above). These determined metrics may then be provided to a TV 102 user and/or PVR 116 as they are generated (or along with the chat room 112 content). An association between a community and a chat room 112 may be made by the logic on a number of bases. The logic may determine an association exists if a user is common to a chat room 112 and a community or if the chat room 112 was created by the logic for that community, or the program content or subject matter of a chat room 112 is of interest to the community. In one embodiment, the chat data may include a chat room 112 identifier that a TV 102/PVR 116 user, receiving the chat data, may use to join the chat room 112 with a wireless communication device 114.

In various embodiments, logic of server 108 may also receive viewing data from a TV 102 of a user. In one embodiment, the viewing data may include viewing data associated with the viewing of programs recorded by a PVR 116 that may be coupled to TV 102. The TV 102 user may be a subscriber to services of server 108. At some interval, such as a time interval or irregular, trigger-defined intervals, the logic of server 108 may create or update additional customized contents and/or content information for members of a community. As described above, the additional contents may be packages of programs/commercials or a programming guide. A generated programming guide may include, for example, shows that would be of particular interest to members of the community. In determining the substance of the additional customized contents and/or content information, the logic of server 108 may retrieve the viewing data of each user listed for a community, and may feed the behavior into a content deciding algorithm. The algorithm may select programs/commercials based on any weighing of criteria that may be determined to be beneficial, including auctioning/selling of priority to a commercial advertiser. Upon creating or updating additional customized contents and/or content information, the logic of server 108 may store a record of the contents in the community records of database 110, to facilitate quick retrieval of the contents. In one embodiment, the logic of server 108 may create or update additional customized contents for individual users. Such customized contents and/or content information may simply comprise a compilation of the additional customized contents and/or content information for each community that the user is a member of. For example, the logic may create/update a programming guide that lists programs of interest to each community that the user is a member of. The logic of server 108 may then store a record of the contents and/or content information in the user records of database 110, to facilitate quick retrieval of the contents. Upon creating/updating the contents and/or content information, the server 108 may transmit the contents to the communities/users that the contents were created/updated for.

As is further shown, wireless communication device 114 may be any sort of wireless device known in the art capable of cellular and/or wireless data communications. Wireless communication device 114 may be, for example, a mobile phone, a personal digital assistant (PDA), or a portable game console. The wireless communication device 114 may include one or more communication means known in the art, such as a wireless networking interface capable of sending and receiving wireless data communications, a cellular communication means capable of making, receiving, and maintaining a cellular phone call, and messaging service means capable of sending and receiving text and/or visual messages. In addition to the one or more communication means, wireless communication device 114 may also include a number of other components, such as a display means, alphanumeric and browsing/selection input means, audio input/output means, a processor, an LED, a tuner, a power supply, such as a battery, and a protective casing, each of any sort known in the art.

In various other embodiments, wireless communication device 114 may serve as a remote control capable of receiving user interface displays from a controllee apparatus, such as TV 102, the user interfaces enabling channel selection, may display the user interface displays to a user to receive selections from the user, and may, in response, provide commands associated with the selections to TV 102. Such user interface displays may constitute, for example, graphic numbered buttons to enable channel selection and graphic arrow keys to enable channel browsing. These interfaces may be displayed, for example, on a touch sensitive display of wireless communication device 114, in embodiments where wireless communication device 114 has such a touch sensitive display. Such a remote control is the subject of the recently issued U.S. patent entitled “Field Extensible Controllee Sourced Universal Remote Control Method and Apparatus,” the citation and incorporation of which is provided above.

In various embodiments, wireless communication device 114 may allow its users to initiate and engage in chat activities facilitated by chat rooms 112 of server 108. The wireless communication device 114 user may subscribe to services of server 108, and may log in to those services through the wireless communication device 114, in one embodiment by entering a code through a wireless communication device 114 keypad. Once logged in, the wireless communication device 114 user may receive invitations to join chat rooms 112, may accept or reject the invitations, may join and invite others, and request that server 108 create a chat room 112. Once the wireless communication device 114 user has joined a chat room, the user may exchange messages with other wireless communication device 114 users. Wireless communication device 114 may also receive chat room 112 metadata, and may display the metadata to its user. In one embodiment, the user of wireless communication device 114 may be the same person as the user of TV 102 and/or PVR 116.

As illustrated, PVR 116 may be any sort of media content recording device known in the art, except for the logic of PVR 116 adapted to perform the operations described above and below. PVR 116 may be a digital video recording set-top device, such as a TiVo DVR, a DVD-R, a VCR, a personal computer (PC), a media storage server, or any other media content recording device known in the art. An exemplary PVR 116 is illustrated by FIG. 3 and is described in further detail below. Also, as is described above, PVR 116 may be connected by one or more networking fabrics to server 108, and/or may be physically coupled to TV 102. PVR 116 may at least include storage to store media and recording assistance information received from server 108, logic to process the received recording assistance information, and a processor to execute the logic. In one embodiment, PVR 116 may comprise a plurality of systems. For example, one system of PVR 116 may include the processor and logic, and another system of PVR 116 may include the memory.

In various embodiments, the logic of PVR 116 may be adapted to observe and report viewing data related to viewing, by a PVR 116 user, the programs stored by PVR 116. For example, the logic may report if a program is watched, and if less than the entire program is watched, PVR 116 may report the amount of time spent watching the program. This viewing data may be reported by the logic of PVR 116 in real time, or may be stored and reported in batches. In another embodiment, logic of PVR 116 may not observe and report viewing data at all, but may leave the observing and reporting to TV 102, as described above.

In further embodiments, the logic of PVR 116 may receive the recording assistance information from server 108, may store the information, and may process the information. For example, if the recording assistance information includes a list of programs, the logic of PVR 116 may record each of the programs on the list, or simply a number of the programs, such the top four. If the recording assistance information includes chat data, the logic may record the chat data for later viewing by a PVR 116 user. If the chat data includes a time plot, the logic may record programs associated with communities of the chat participants at times when the chatting activity reached a frequency threshold (such as ten messages per minute). To record a program, the logic of PVR 116 may request the program(s) from server 108, and may, in turn, receive and store the program(s) for later viewing.

FIG. 2 is a block diagram illustrating an internal component view of an example television set suitable for use to practice the present invention, in accordance with various embodiments. As shown, television set 200 includes one or more processors 202 and system memory 204. Additionally, television set 200 includes mass storage devices 206 (such as diskette, hard drive, CDROM and so forth), GPIO 207, video adapter 208, and communication interfaces 210 (such as serial, parallel, USB, or IEEE 1394 based wired interfaces, Bluetooth/IEEE 802.11 based wireless interfaces), including transceiver 106 and a tuner. The elements are coupled to each other via system bus 212, which represents one or more buses. In the case of multiple buses, they are bridged by one or more bus bridges (not shown).

Each of these elements performs its conventional functions known in the art. In particular, system memory 204 and mass storage 206 may be employed to store a working copy and a permanent copy of the programming instructions implementing selected ones or all of the various components of embodiments of the present invention, such as the processes illustrated by FIG. 1, herein collectively denoted as 222. The various components may be implemented as assembler instructions supported by processor(s) 202 or high-level languages, such as C, that can be compiled into such instructions.

The permanent copy of the programming instructions may be placed into permanent storage 206 in the factory or in the field, through, for example, a distribution medium (not shown) or through communication interface 210 (from a distribution server (not shown)).

The constitution of these elements 202-212 is known, and accordingly will not be further described.

FIG. 3 is a block diagram illustrating an example computer system suitable for use to practice the server and/or personal video recorder aspects of the present invention, in accordance with various embodiments. As shown, computing system 300 includes one or more processors or processor cores 302, and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CDROM) and so forth), input/output devices 308 (such as keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing all or a portion of earlier described server/PVR functions, herein collectively denoted as 322. The instructions 322 may be assembler instructions supported by processor(s) 302 or instructions that can be compiled from high level languages, such as C.

The permanent copy of the programming instructions may be placed into permanent storage 306 in the factory, or in the field, through, for example, a distribution medium (not shown), such as a compact disc (CD), or through communication interface 310 (from a distribution server (not shown)). That is, one or more distribution media having instructions 322 may be employed to distribute the instructions 322 and program various computing devices.

The constitution of these elements 302-312 are known, and accordingly will not be further described.

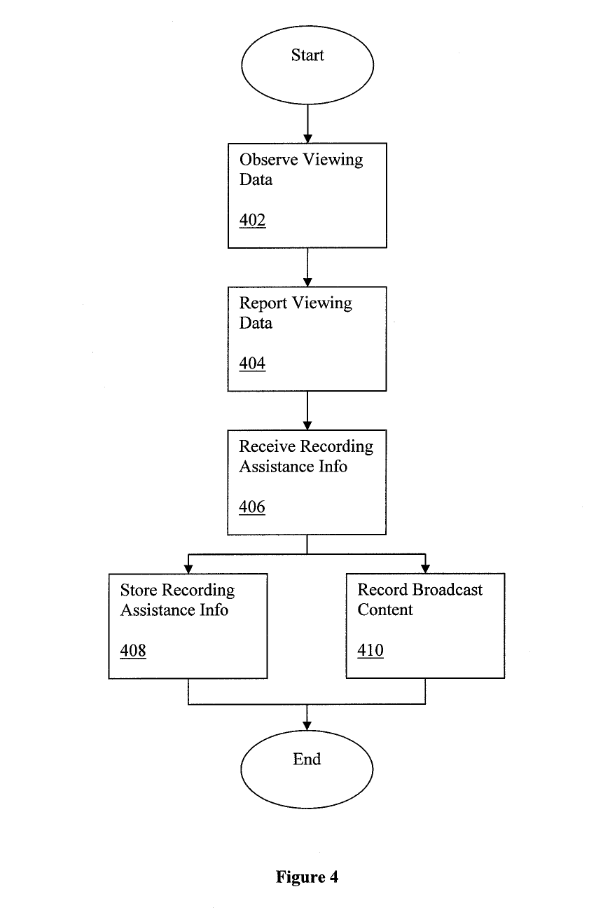

FIG. 4 illustrates a flowchart view of selected recording device operations, in accordance with various embodiments. As illustrated, a recording device may first observe viewing data associated with a recording device user's viewing of stored broadcast or multicast content and/or recording assistance information, block 402. Upon observing the viewing data, the recording device may report at least a subset or a summary of the observed viewing data to a server that is remotely disposed from the recording device, block 404.

In some embodiments, the recording device may be one of a digital video recorder, a digital video disc recorder, a video cassette recorder, a personal computer, or a media storage server. The recording assistance device may be customized content and/or content information, the customized content and/or content information including one or more of a directive to record the broadcast or multicast content, a list of broadcast or multicast contents available for recording and/or purchase, the broadcast or multicast contents, or chat data associated with the at least one community. In one embodiment, the broadcast or multicast content(s) specified by the directive or list or included with the recording assistance information comprises favorite or most-frequently viewed broadcast or multicast content(s) of members of the at least one community. In various embodiments, the at least one community may be a geographic community, a community organized around a common interest, or a community organized around a demographic trait.

As shown, the recording device may further receive from a serve recording assistance information determined for the recording device by the server based on at least one community to which a user of the recording device belongs, block 406. In response, the recording device may perform at least one of storing the recording assistance information for consumption by the user of the recording device, block 408, or recording broadcast or multicast content based on the community-based recording assistance information, block 410. In one embodiment, the recording comprises recording only portions of broadcast or multicast content for which there is a correlation or association with chat data of the recording assistance information.

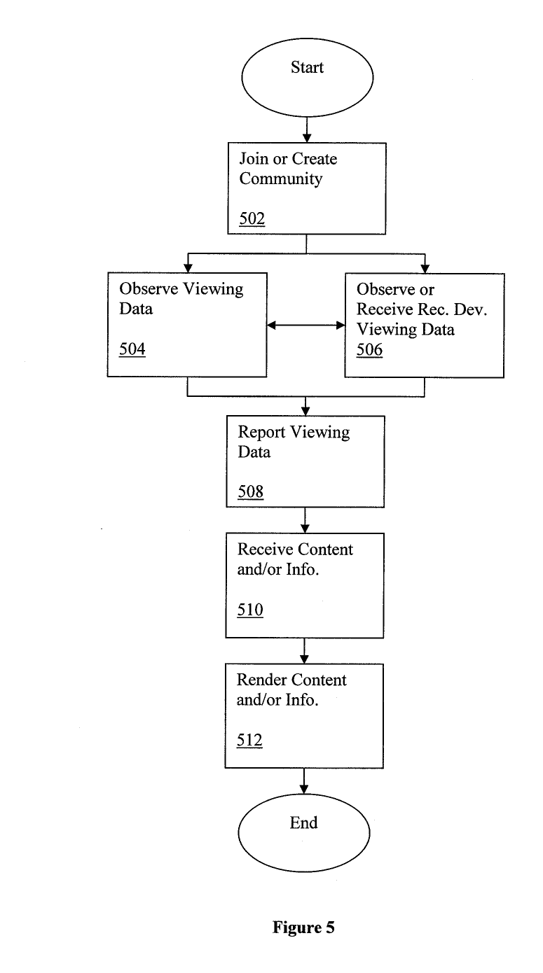

FIG. 5 illustrates a flowchart view of selected television operations, in accordance with various embodiments. As illustrated, a television may facilitate a television user in joining or creating at least one community, block 502. The at least one community may be a geographic community, a community organized around a common interest, or a community organized around a demographic trait.

In various embodiments, the television may further observe viewing data associated with the television user's viewing of received content information, customized content, and/or other broadcast or multicast content, block 504. In one embodiment, the television may also or instead receive additional viewing data from a recording device coupled to the television or may observe the additional viewing data, block 506. Upon observing or receiving viewing data and/or additional viewing data, the television may report at least a subset or a summary of the observed/received viewing data and/or additional viewing data to a server that is remotely disposed from the television, block 508.

As shown, the television may then receive from a server content information and/or customized content having been determined for the television by the server based on at least one community to which the user of the television belongs, block 510. In various embodiments, the customized content may include one or more of chat data, commercial(s), television programs, or movies, and the content information may include a programming guide custom-created for the at least one community. In one embodiment, the customized content and/or content information may comprise favorite or most-frequently viewed broadcast or multicast content(s) of members of the at least one community. In response to receiving, the television may then render the content information and/or customized content, block 512.

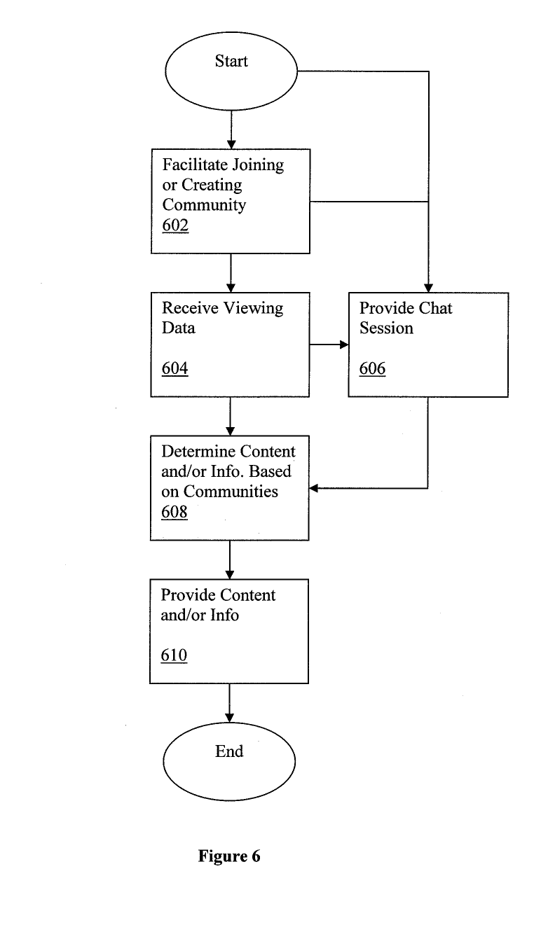

FIG. 6 illustrates a flowchart view of selected server operations, in accordance with various embodiments. As illustrated, a server may facilitate a recording or rendering device user in joining or creating at least one community, block 602. The at least one community may be a geographic community, a community organized around a common interest, or a community organized around a demographic trait.

In various embodiments, the server may further receive from a recording or rendering device that is remotely disposed from the server viewing data or a summary of viewing data associated with the user's viewing of content information, customized content, and/or other broadcast or multicast content, block 604. In one embodiment, the customized content and/or content info include one or more of chat data, broadcast or multicast contents, a programming guide custom-created for the at least one community, a bundle of a plurality of broadcast or multicast contents, a directive to record broadcast or multicast content, or a list of broadcast or multicast contents available for recording and/or purchase.

In some embodiment, the server may also provide a chat session between members of the at least one community, block 606.

As shown, the server may determine content information and/or customized content for the recording or rendering device based on at least one community to which a user of the device belongs, block 608. In some embodiments, the determining may be at least partially in view of the viewing data or summary of viewing data received from the device. The determining may also comprise creating the content information and/or customized content. In one embodiment, determining may comprise including chat data about the chat session in the provided content information and/or customized content. In response to the determining, the server may provide the content information and/or customized content to the device to enable consumption of the content information and/or customized content or recording of broadcast or multicast content, block 610.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. Those skilled in the art will readily appreciate that the present invention may be implemented in a very wide variety of embodiments or extended therefrom. This application is intended to cover any adaptations or variations of the embodiments discussed herein. Therefore, it is manifestly intended that this invention be limited only by the claims and the equivalents thereof.

What is claimed is:

1. A method comprising:
receiving by a recording device, from a server remotely disposed from the recording device, recording assistance information determined for the recording device by the server based on at least one community to which a user of the recording device belongs; and
at least one of
storing, by the recording device, the recording assistance information for consumption by the user of the recording device, or
recording, by the recording device, broadcast or multicast content based on the community-based recording assistance information.

2. The method of claim 1, further comprising:
observing, by the recording device, viewing data associated with a recording device user's viewing of stored broadcast or multicast content and/or recording assistance information; and
reporting, by the recording device, at least a subset or a summary of the observed viewing data to the server.

3. The method of claim 1, wherein the recording assistance information comprises content information and/or customized content, and the content information and/or customized content includes one or more of a directive to record the broadcast or multicast content, a list of broadcast or multicast contents available for recording and/or purchase, the broadcast or multicast contents, or chat data associated with the at least one community.

4. The method of claim of 3, wherein the recording comprises recording only portions of the broadcast or multicast content for which there is a correlation or association with the chat data.

5. The method of claim of 3, wherein the at least one community is a geographic community, a community organized around one or more common interest, or a community organized around one or more demographic traits.

6. The method of claim 3, wherein the broadcast or multicast content(s) specified by the directive or list or included with the recording assistance information comprises favorite or most-frequently viewed broadcast or multicast content(s) of members of the at least one community.

7. A recording device comprising:
a processor; and
logic to be operated by the processor to enable the recording device to
receive, from a server remotely disposed from the recording device, recording assistance information determined for the recording device by the server based on at least one community to which a user of the recording device belongs; and
at least one of
store the recording assistance information for consumption by the user of the recording device, or
record broadcast or multicast content based on the community-based recording assistance information.

8. The recording device of claim 7, wherein the recording assistance information comprises content information and/or customized content, and the content information and/or customized content includes one or more of a directive to record the broadcast or multicast content, a list of broadcast or multicast contents available for recording and/or purchase, the broadcast or multicast contents, or chat data associated with the at least one community.

9. A method comprising:
receiving by a television, from a server remotely disposed from the television, content information and/or customized content having been determined for the television by the server based on at least one community to which a user of the television belongs; and
rendering, by the television, the content information and/or customized content.

10. The method of claim 9, further comprising:
observing, by the television, viewing data associated with a television user's viewing of the content information, customized content, and/or other broadcast or multicast content; and
reporting, by the television, at least a subset or a summary of the observed viewing data to the server.

11. The method of claim 10, wherein the television is coupled to a recording device, and the method further comprises:
receiving, by the television, additional viewing data from the recording device or observing, by the television, the additional viewing data, and
reporting, by the television, at least a subset or a summary of the additional viewing data to the server.

12. The method of claim 9, wherein the at least one community is a geographic community, a community organized around a common interest, or a community organized around a demographic trait.

13. The method of claim 9, further comprising facilitating, by the television, the user in joining or creating the at least one community.

14. The method of claim 9, wherein the customized content includes one or more of chat data, commercial(s), television programs, or movies, and the content information includes a programming guide custom-created for the at least one community.

15. The method of claim 9, wherein the customized content and/or content information comprises favorite or most-frequently viewed broadcast or multicast content(s) of members of the at least one community.

16. A method comprising:
determining, by a server, content information and/or customized content for a content recording or rendering device remotely disposed from the server, the determining being based on at least one community to which a user of the device belongs; and
providing, by the server, the content information and/or customized content to the device to enable consumption of the content information and/or customized content or recording of broadcast or multicast content.

17. The method of claim 16, further comprising receiving from the device, by the server, viewing data or a summary of viewing data associated with the user's viewing of the content information, customized content, and/or other broadcast or multicast content.

18. The method of claim 17, wherein the determining based on the at least one community is at least partially in view of the received viewing data or summary of viewing data.

19. The method of claim 16, wherein the customized content and/or content info include one or more of chat data, broadcast or multicast contents, a programming guide custom-created for the at least one community, a bundle of a plurality of broadcast or multicast contents, a directive to record broadcast or multicast content, or a list of broadcast or multicast contents available for recording and/or purchase.

20. The method of claim 16, wherein the determining comprises creating the content information and/or customized content.

21. The method of claim 16, wherein the at least one community is a geographic community, a community organized around a common interest, or a community organized around a demographic trait.

22. The method of claim 21, further comprising facilitating, by the server, the user in joining or creating the at least one community.

23. The method of claim 16, further comprising providing, by the server, a chat session between members of the at least one community, and said determining comprises including, by the server, chat data about the chat session in the provided content information and/or customized content.

24. A server comprising:
a processor; and
service logic to be operated by the processor to
facilitate a user of a recording or rendering device that is remotely disposed from the server in selecting at least one community to be associated with,
determine content information and/or customized content for the device based on the at least one community to which the user belongs, and
provide the content information and/or customized content to the device to enable consumption of the content information and/or customized content or recording of broadcast or multicast content.

25. The server of claim 24, further comprising a database to store viewing data, content information and/or customized content, user registrations, and community information.
